(19) United States
(12) Patent Application Publication
(10) Pub. No.: US 2007/0005907 A1
(43) Pub. Date: Jan. 4, 2007

(54) Reduction of snoop accesses

(75) Inventors: James P. Kardach, Saratoga, CA (US); David Williams, San Jose, CA (US)

Correspondence Address: CAVEN & AGHEVLI;c/o PORTFOLIOIP, P.O. BOX 52050, MINNEAPOLIS, MN, 55402, US

(73) Assignee: Intel Corporation

(21) Appl. No.: 11/169,854

(22) Filed: Jun. 29, 2005

(51) Int. Cl. G06F 13/28

(52) U.S. Cl. 711/146

(57) ABSTRACT

Techniques that may be utilized in reduction of snoop accesses are described. In one embodiment, a method includes receiving a page snoop command that identifies a page address corresponding to a memory access request by an input/output (I/O) device. One or more cache lines that match the page address may be evicted. Furthermore, memory access by a processor core may be monitored to determine whether the processor core memory access is within the page address.

### BACKGROUND

To improve performance, some computer systems may include one or more caches. A cache generally stores data corresponding to original data stored elsewhere or computed earlier. To reduce memory access latency, once data is stored in a cache, future use may be made by accessing a cached copy rather than refetching or recomputing the original data.

One type of cache utilized by computer systems is a Central processing unit (CPU) cache. Since a CPU cache is closer to a CPU (e.g., provided inside or near the CPU), it allows the CPU to more quickly access information, such as recently used instructions and/or data. Hence, utilization of a CPU cache may reduce latency associated with accessing a main memory provided elsewhere in a computer system. The reduction in memory access latency, in turn, improves system performance. However, each time a CPU cache is accessed, the corresponding CPU may enter a higher power utilization state to provide cache access support functionality, e.g., to maintain the coherency of the CPU cache.

Higher power utilization may increase heat generation. Excessive heat may damage components of a computer system. Also, higher power utilization may increase battery consumption, e.g., in mobile computing devices, which in turn reduces the amount of time a mobile device may be used prior to recharging. The additional power consumption may additionally result in utilization of larger batteries the may weigh more. Heavier batteries reduce portability of a mobile computing device.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-3 illustrate block diagrams of computing systems in accordance with some embodiments of the invention.

FIG. 4 illustrates an embodiment of a method for reducing snoop accesses performed by a processor.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

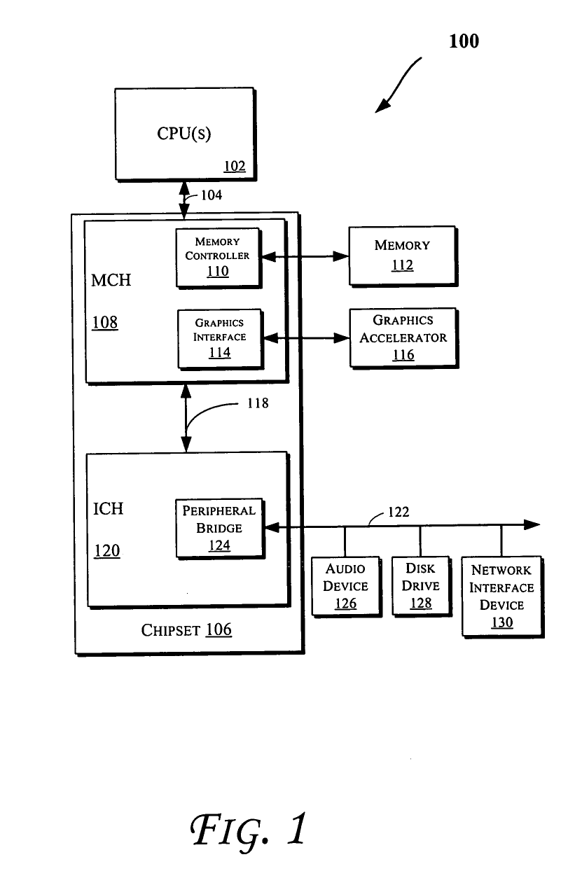

FIG. 1 illustrates a block diagram of a computing system 100 in accordance with an embodiment of the invention. The computing system 100 may include one or more central processing unit(s) (CPUs) 102 or processors coupled to an interconnection network (or bus) 104. The processors (102) may be any suitable processor such as a general purpose processor, a network processor, or the like (including a reduced instruction set computer (RISC) processor or a complex instruction set computer (CISC)). Moreover, the processors (102) may have a single or multiple core design. The processors (102) with a multiple core design may integrate different types of processor cores on the same integrated circuit (IC) die. Also, the processors (102) with a multiple core design may be implemented as symmetrical or asymmetrical multiprocessors.

A chipset 106 may also be coupled to the interconnection network 104. The chipset 106 may include a memory control hub (MCH) 108. The MCH 108 may include a memory controller 110 that is coupled to a memory 112. The memory 112 may store data and sequences of instructions that are executed by the CPU 102, or any other device included in the computing system 100. In one embodiment of the invention, the memory 112 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 104, such as multiple CPUs and/or multiple system memories.

The MCH 108 may also include a graphics interface 114 coupled to a graphics accelerator 116. In one embodiment of the invention, the graphics interface 114 may be coupled to the graphics accelerator 116 via an accelerated graphics port (AGP). In an embodiment of the invention, a display (such as a flat panel display) may be coupled to the graphics interface 114 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 118 may couple the MCH 108 to an input/output control hub (ICH) 120. The ICH 120 may provide an interface to input/output (I/O) devices coupled to the computing system 100. The ICH 120 may be coupled to a bus 122 through a peripheral bridge (or controller) 124, such as a peripheral component interconnect (PCI) bridge, a universal serial bus (USB) controller, or the like. The bridge 124 may provide a data path between the CPU 102 and peripheral devices. Other types of topologies may be utilized. Also, multiple buses may be coupled to the ICH 120, e.g., through multiple bridges or controllers. Moreover, other peripherals coupled to the ICH 120 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 122 may be coupled to an audio device 126, one or more disk drive(s) 128, and a network interface device 130. Other devices may be coupled to the bus 122. Also, various components (such as the network interface device 130) may be coupled to the MCH 108 in some embodiments of the invention. In addition, the CPU 102 and the MCH 108 may be combined to form a single chip. Furthermore, the graphics accelerator 116 may be included within the MCH 108 in other embodiments of the invention.

Additionally, the computing system 100 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 128), a floppy disk, a compact disk ROM (CD-ROM), a digital versatile disk (DVD), flash memory, a magneto-optical disk, or other types of nonvolatile machine-readable media suitable for storing electronic instructions and/or data.

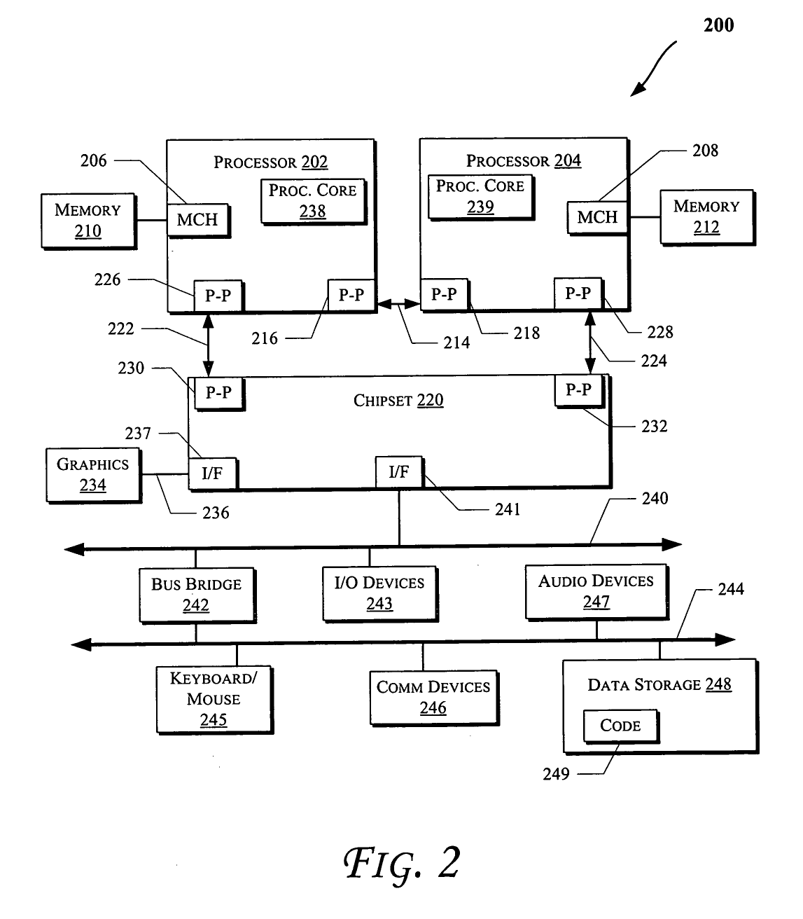

FIG. 2 illustrates a computing system 200 that is arranged in a point-to-point (PtP) configuration, according to an embodiment of the invention. In particular, FIG. 2 shows a system where processors, memory, and input/output devices are interconnected by a number of point-to-point interfaces.

The system 200 of FIG. 2 may also include several processors, of which only two, processors 202 and 204 are shown for clarity. The processors 202 and 204 may each include a local memory controller hub (MCH) 206 and 208 to couple with memory 210 and 212. The processors 202 and 204 may be any suitable processor such as those discussed with reference to the processors 102 of FIG. 1. The processors 202 and 204 may exchange data via a point-to-point (PtP) interface 214 using PtP interface circuits 216 and 218, respectively. The processors 202 and 204 may each exchange data with a chipset 220 via individual PtP interfaces 222 and 224 using point to point interface circuits 226, 228, 230, and 232. The chipset 220 may also exchange data with a high-performance graphics circuit 234 via a high-performance graphics interface 236, using a PtP interface circuit 237.

At least one embodiment of the invention may be located within the processors 202 and 204. Other embodiments of the invention, however, may exist in other circuits, logic units, or devices within the system 200 of FIG. 2. Furthermore, other embodiments of the invention may be distributed throughout several circuits, logic units, or devices illustrated in FIG. 2.

The chipset 220 may be coupled to a bus 240 using a PtP interface circuit 241. The bus 240 may have one or more devices coupled to it, such as a bus bridge 242 and I/O devices 243. Via a bus 244, the bus bridge 242 may be coupled to other devices such as a keyboard/mouse 245, communication devices 246 (such as modems, network interface devices, or the like), audio I/O device 247, and/or a data storage device 248. The data storage device 248 may store code 249 that may be executed by the processors 202 and/or 204.

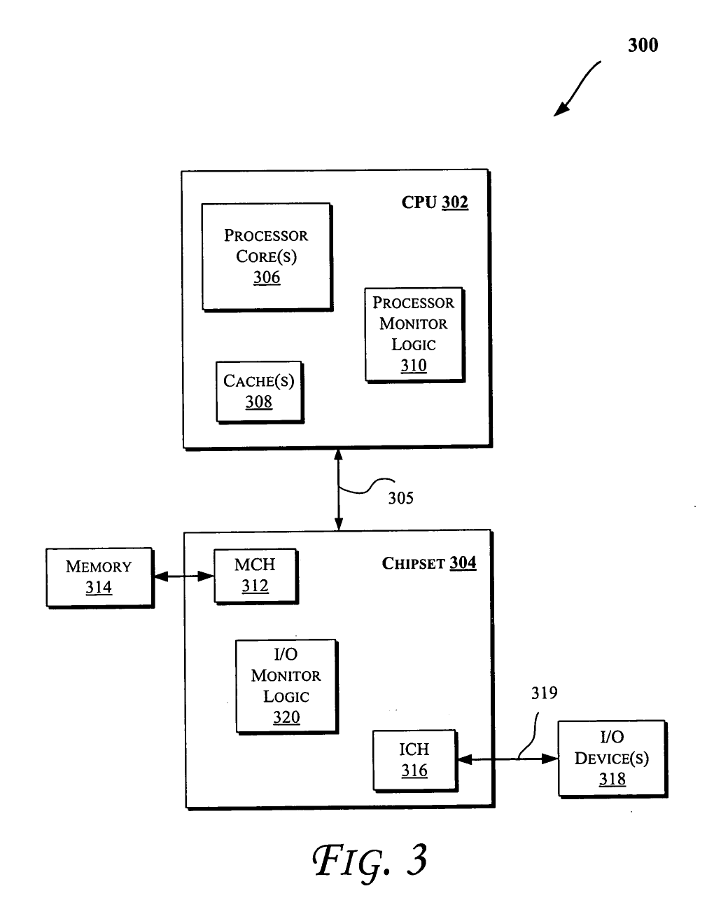

FIG. 3 illustrates an embodiment of a computing system 300. The system 300 may include a CPU 302. In an embodiment, the CPU 302 may be any suitable processor, such as the processors 102 of FIG. 1 or 202-204 of FIG. 2. The CPU 302 may be coupled to a chipset 304 via an interconnection network 305 (such as the interconnection 104 of FIG. 1 or the PtP interfaces 222 and 224 of FIG. 2). In an embodiment, the chipset 304 is the same or similar to the chipsets 106 of FIG. 1 or 220 of FIG. 2.

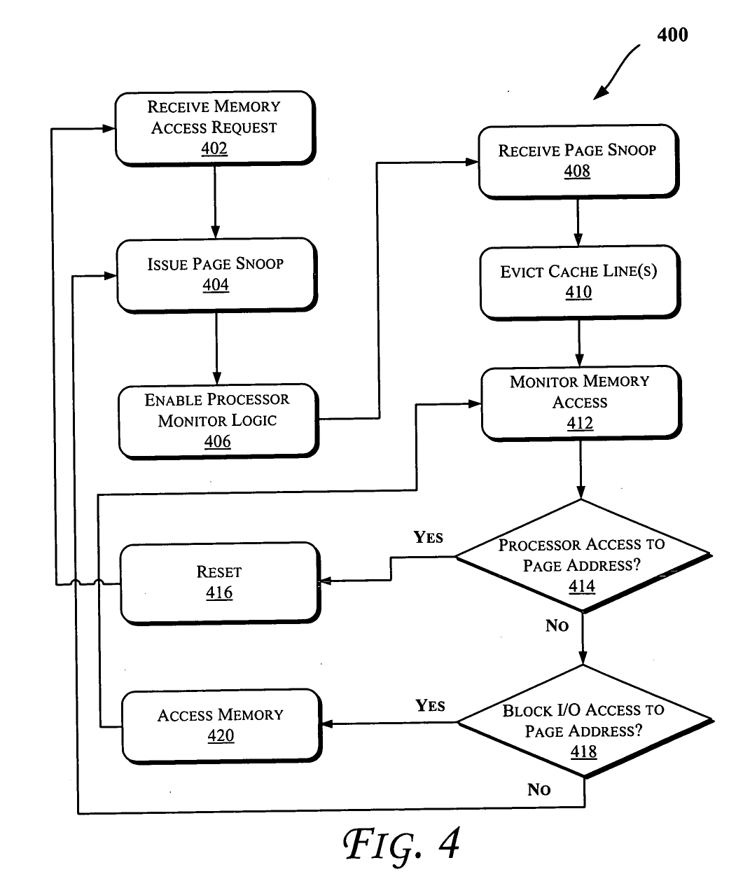

The CPU 302 may include one or more processor cores 306 (such as discussed with reference to the processors 102 of FIG. 1 or 202-204 of FIG. 2). The CPU 302 may also include one or more cache(s) 308 (that may be shared in one embodiment of the invention), such a level 1 (L1) cache, a level 2 (L2) cache, a level 3 (L-3), or the like to store instructions and/or data that are utilized by one or more components of the system 300. Various components of the CPU 302 may be coupled to the cache(s) 308 directly, through a bus, and/or memory controller or hub (e.g., the memory controller 110 of FIG. 1, MCH 108 of FIG. 1, or MCH 206-208 of FIG. 2). Also, included within the CPU 302 may be one or more components which address the handling of memory snooping functionality, as will be further discussed with reference to FIG. 4. For example, a processor monitor logic 310 may be included to monitor memory accesses by the processor core(s) 306. Various components of the CPU 302 may be provided on a same integrated circuit die.

As illustrated in FIG. 3, the chipset 304 may include an MCH 312 (such as MCH 108 of FIG. 1 or MCH 206-208 of FIG. 2) that provides access to a memory 314 (such as memory 112 of FIG. 1 or memories 210-212 of FIG. 2). Hence, the processor monitor logic 310 may monitor memory accesses by the processor core(s) 306 to the memory 314. The chipset 304 may further include an ICH 316 to provide access to one or more I/O device(s) 318 (such as those discussed with reference to FIGS. 1 and 2). The ICH 316 may include a bridge to allow communication with various I/O device(s) 318 through a bus 319, such as the ICH 120 of FIG. 1 or the PtP interface circuit 241 that is coupled to the bus bridge 242 of FIG. 2. In an embodiment, the I/O device(s) 318 may be block I/O device(s) that are capable of transferring data to and from the memory 314.

Also, included within the chipset 304 may be one or more components which address the handling of memory snooping functionality, as will be further discussed with reference to FIG. 4. For example, an I/O monitor logic 320 may be included to provide a page snoop command that evicts one or more cache lines within the cache(s) 308. The I/O monitor logic 320 may further enable the processor monitor logic 310, e.g., based on the traffic from the I/O device(s) 318. Hence, the I/O monitor logic 320 may monitor the traffic to and from the I/O device(s) 318, such as a memory access to the memory 314 by the I/O device(s) 318. In one embodiment, the I/O monitor logic 320 may be coupled between a memory controller (e.g., the memory controller 110 of FIG. 1) and a peripheral bridge (e.g., the bridge 124 of FIG. 1). Also, the I/O monitor logic 320 may be inside the MCH 312. Various components of the chipset 304 may be provided on a same integrated circuit die. For example, the I/O monitor logic 320 and a memory controller (e.g., the memory controller 110 of FIG. 1) may be provided on a same integrated circuit die.

FIG. 4 illustrates an embodiment of a method 400 for reducing snoop accesses performed by a processor. Generally, a snoop access may be issued to the processor core(s) 306 when the main memory (e.g., 314) is accessed, e.g., to maintain memory coherency. In an embodiment, the snoop accesses may be due to traffic by the I/O device(s) 318 of FIG. 3. For example, a controller for a block I/O device (such as a USB controller) may periodically access the memory 314. Each access by the I/O device(s) 318 may invoke a snoop access (e.g., by the processor core(s) 306) to determine whether the memory regions being accessed (e.g., portion of the memory 314) is within the cache(s) 308, for example, to maintain coherency of the cache(s) 308 with the memory 314.

In one embodiment, various components of the system 300 of FIG. 3 may be utilized to perform the operations discussed with reference to FIG. 4. For example, stages 402-404 and (optionally) 410 may be performed by the I/O monitor logic 320. Stages 406 and 408 may be performed by the processor core(s) 306. Stage 416 may be performed by the MCH 312 and/or the I/O device(s) 318. Stages 412-414 and 418-420 may be performed by the processor monitor logic 310.

Referring to both FIGS. 3 and 4, the I/O monitor logic 320 may receive a memory access request (402) from one or more block I/O device(s) 318. The I/O monitor logic 320 may parse the received request (402) to determine the corresponding region of memory (e.g., in the memory 314). The I/O monitor logic 320 may issue a page snoop command (404) that identifies a page address corresponding to the memory access by the block I/O device 318. For example, the page address may identify a region within the memory 314. In an embodiment, the I/O device(s) 318 may access 4 Kbytes or 8 Kbytes consecutive regions of memory.

The I/O monitor logic 320 may enable the processor monitor logic 310 (406). The processor core(s) 306 may receive the page snoop (408) (e.g., generated at the stage 404), and evict one or more cache lines (410), e.g., in the cache(s) 308. At a stage 412, memory accesses may be monitored. For example, the I/O monitor logic 320 may monitor the traffic to and from the I/O device(s) 318, e.g., by monitoring transactions on a communication interface such as the hub interface 118 of FIG. 1 or the bus 240 of FIG. 2. Also, after being enabled (406), the processor monitor logic 310 may monitor memory accesses by the processor core(s) 306 (412). For example, the processor monitor logic 310 may monitor the memory transactions on the interconnection network 305 that attempt to access the memory 314.

At a stage 414, if the processor monitor logic 310 determines that the memory access by the processor core(s) 306 is to the page address of stage 404, the processor and/or I/O monitor logics (310 and 320) may be reset at a stage 416, e.g., by the processor monitor logic 310. Hence, the monitoring of the memory access (412) may be stopped. After stage 416, the method 400 may continue at the stage 402. Otherwise, if at the stage 414, the processor monitor logic 310 determines that the memory access by the processor core(s) 306 is not to the page address of stage 404, the method 400 may continue with a stage 418.

At the stage 418, if the I/O monitor logic 320 determines that the memory access by a block I/O device (318) is to the page address of stage 404, memory (314) may be accessed (420), e.g., without generating a snoop request to the processor core(s) 306. Otherwise, the method 400 resumes at the stage 404 to handle the block I/O device's (318) memory access request to a new region of the memory (314). Even though FIG. 4 illustrates that the stage 414 may precede the stage 418, the stage 414 may be performed after the stage 418. Also, the stages 414 and 418 may be performed asynchronously in an embodiment.

In an embodiment, the data to and from the I/O device(s) 318 may be loaded into the cache(s) 308 less frequently than other content which is accessed by the processor core(s) 306 more frequently. Accordingly, the method 400 may reduce the snoop accesses performed by a processor (e.g., processor core(s) 306), where memory accesses are generated by block I/O device traffic to a page address (404) that has already been evicted from the cache(s) 308. Such an implementation allows a processor (e.g., the processor core(s) 306) to avoid leaving a lower power state to perform a snoop access.

For example, implementations that follow the ACPI specification (Advanced Configuration and Power Interface specification, Revision 3.0, Sep. 2, 2004) may allow a processor (e.g., the processor core(s) 306) to reduce the time it spends at the C2 state which utilizes more power than the C3 state. For each USB device memory access (which may occur every 1 ms regardless of whether the memory access requires a snoop access), the processor (e.g., the processor core(s) 306) may enter a C2 state to perform the snoop access. The embodiments discussed herein, e.g., with reference to FIGS. 3 and 4, may limit unnecessary snoop access generation, e.g., where a block I/O device is accessing a previously evicted page address (404, 410). Hence, a single snoop access may be generated (404) and the corresponding cache lines evicted (410) for commonly utilized regions of a memory (314). Reduced power consumption may result in longer battery life and/or less bulky batteries in mobile computing devices.

In various embodiments, one or more of the operations discussed herein, e.g., with reference to FIGS. 1-4, may be implemented as hardware (e.g., logic circuitry), software, firmware, or combinations thereof, which may be provided as a computer program product, e.g., including a machine-readable or computer-readable medium having stored thereon instructions used to program a computer to perform a process discussed herein. The machine-readable medium may include any suitable storage device such as those discussed with reference to FIGS. 1-3.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with that embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a processor core to:
receive a page snoop command that identifies a page address corresponding to a memory access request by an input/output (I/O) device; and
evict one or more cache lines that match the page address; and
a processor monitor logic to monitor a memory access by the processor core to determine whether the processor core memory access is within the page address.

2. The apparatus of claim 1, wherein the one or more cache lines are in a cache coupled to the processor core.

3. The apparatus of claim 2, wherein the cache is on a same integrated circuit die as the processor core.

4. The apparatus of claim 1, wherein the page address identifies a region of a memory coupled to the processor core through a chipset.

5. The apparatus of claim 4, wherein the chipset comprises an I/O monitor logic to monitor a memory access by the I/O device.

6. The apparatus of claim 5, wherein the chipset comprises a memory controller and the I/O monitor is coupled between the I/O device and the memory controller.

7. The apparatus of claim 6, wherein the I/O monitor logic is on a same integrated circuit die as the memory controller.

8. The apparatus of claim 1, further comprising a plurality of processor cores.

9. The apparatus of claim 8, wherein the plurality of processor cores are on a single integrated circuit die.

10. A method comprising:
receiving a page snoop command that identifies a page address corresponding to a memory access request by an input/output (I/O) device;
evicting one or more cache lines that match the page address;
monitoring a memory access by a processor core to determine whether the processor core memory access is within the page address.

11. The method of claim 10, further comprising stopping the monitoring of the memory access if the processor core memory access is within the page address.

12. The method of claim 10, further comprising accessing a memory coupled to the processor core if an I/O memory access is within the page address.

13. The method of claim 12, wherein the memory is accessed without generating a snoop access.

14. The method of claim 10, further comprising monitoring a memory access by the I/O device.

15. The method of claim 10, wherein the processor core memory access performs a read or a write operation on a memory coupled to the processor core.

16. The method of claim 10, further comprising receiving the memory access request from the I/O device, wherein the memory access request identifies a region within a memory coupled to the processor core.

17. The method of claim 10, further comprising enabling a processor monitor logic to monitor the memory access by the processor core, after receiving the memory access request.

18. A system comprising:
a volatile memory to store data;
a processor core to:
receive a page snoop command that identifies a page address corresponding to an access request to the memory by an input/output (I/O) device; and
evict one or more cache lines that match the page address; and
a processor monitor logic to monitor an access to the memory by the processor core to determine whether the processor core memory access is within the page address.

19. The system of claim 18, further comprising a chipset coupled between the memory and the processor core, wherein the chipset comprises an I/O monitor logic to monitor a memory access by the I/O device.

20. The system of claim 18, wherein the volatile memory is a RAM, DRAM, SDRAM, or SRAM.
